(19) United States
(12) Patent Application Publication
(10) Pub. No.: US 2020/0198266 A1
(43) Pub. Date: Jun. 25, 2020

(54) ANNEALED UNIDIRECTIONAL THERMOPLASTIC COMPOSITE TAPE

(71) Applicant: RESINFIBER, LLC, Saco, ME (US)

(72) Inventors: Joel A. Dyksterhouse, Cross Village, MI (US); Thomas L. Yale, Saco, ME (US); Bruce Goodrich, Lebanon, ME (US)

(73) Assignee: RESINFIBER, LLC, Saco, ME (US)

(21) Appl. No.: 16/716,406

(22) Filed: Dec. 16, 2019

Related U.S. Application Data
(60) Provisional application No. 62/781,913, filed on Dec. 19, 2018.

(51) Int. Cl. B29C 71/02; B29C 70/56; B29B 11/10; B29C 48/00

(52) U.S. Cl. CPC B29C 71/02; B29C 70/56; B29K 2067/00; B29C 48/022; B29C 2071/022; B29B 11/10

(57) ABSTRACT

A method for forming an annealed thermoplastic tape is disclosed. The method includes supplying continuous fibers to an extrusion device, supplying a thermoplastic feedstock to the extrusion device, wherein the feedstock comprises a thermoplastic polymer, pre-heating, tensioning, spreading, and flattening the continuous fibers, extruding the continuous fibers and the feedstock within an impregnation die to form an extrudate in which the continuous fibers are embedded with a matrix of the thermoplastic polymer while under continuous tension and heat, and maintaining the continuous tension on the extrudate until cooled to a solid thermoplastic tape. The resulting annealed thermoplastic tape is formed of a plurality of unidirectional fibers, and a thermoplastic resin.

### TECHNICAL FIELD

This disclosure relates to unidirectional thermoplastic tape, and more particularly to annealed unidirectional thermoplastic composite tape.

### BACKGROUND

The statements in this section merely provide background information related to the present disclosure and may not constitute prior art.

Unidirectional Thermoplastic Composite Tapes have been in production since the early 1980's. These tapes have encompassed the combination of many different reinforcement fibers and matrix polymers. These combinations of polymers and fibers have been utilized in almost all industries due to their high strength to weight ratios. These thermoplastic composite tapes always require multiple tapes, a mold or tool, and finally heat and pressure for a given amount of time, to consolidate them into a final part. The unidirectional thermoplastic composite tapes are therefore always an intermediate that requires these further steps to achieve full mechanical properties and are only viable when configured into a final part.

Further, all known unidirectional thermoplastic composite tapes reinforcements start as fiber bundles, roving's, or tows that are comprised of thousands of individual filaments. During the normal impregnation processes these filaments are coated with thermoplastic resin then allowed to solidify into a tape where all of the filaments are under a varying amount of tension and, in the case of polymer fibers, not annealed. These tapes, being formed under of a varying amount of tension, have some fibers that were impregnated with polymer under tension and some fibers that were not impregnated with polymer under tension. The fibers that were not impregnated with polymer under tension are generally weaker than the fibers impregnated with polymer formed under tension. The tape, therefore, performs undesirably, and often will perform consistent with the weaker fibers—the entire tape is often only as strong as the weakest part.

Accordingly, a need exists for a fully annealed thermoplastic composite tape having enhanced mechanical properties and a simplified the manufacturing process.

### SUMMARY

A method for forming an annealed thermoplastic tape is disclosed. The method includes supplying continuous fibers to an extrusion device, supplying a thermoplastic feedstock to the extrusion device, wherein the feedstock comprises a thermoplastic polymer, pre-heating, tensioning, spreading, and flattening the continuous fibers, extruding the continuous fibers and the feedstock within an impregnation die to form an extrudate in which the continuous fibers are embedded with a matrix of the thermoplastic polymer while under continuous tension and heat, and maintaining the continuous tension on the extrudate until cooled to a solid thermoplastic tape. The resulting annealed thermoplastic tape is formed of a plurality of unidirectional fibers, and a thermoplastic resin.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows an exemplary impregnation system, in accordance with the present disclosure;

FIG. 2 shows another embodiment of an impregnation die, in accordance with the present disclosure; and

FIG. 3 shows an exemplary process for forming an annealed thermoplastic tape, in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

Generally, the present disclosure is directed to a unidirectional thermoplastic composite tape formed of a plurality of unidirectionally aligned continuous fibers embedded within a polymer. Although unique polymer and fiber combinations are one aspect of the present disclosure, it should be understood that fiber properties, fiber types, and fiber structure may also be adapted. In fact, one notable feature of the present disclosure is the ability to tailor the mechanical properties of the prepreg for an intended application by selectively controlling certain process parameters, such as the type of continuous fibers employed, the concentration of the continuous fibers, along with the thermoplastic resin used.

The term “continuous fibers” refers to fibers, filaments, yarns, or rovings (e.g., bundles of fibers) having a length that is generally limited only by the length of the part. For example, such fibers may have a length greater than about 25 millimeters, in some embodiments about 50 millimeters or more, and in some embodiments, about 100 millimeters or more. The continuous fibers may be formed from any conventional material known in the art, such as high density polyethylene fibers (HDPE), synthetic organic fibers (e.g., linear polyesters, polyamide, polyethylene, and polyphenylene sulfide, nylon-based fibers), carbon fibers (e.g., graphite), boron fibers, aramid fibers (e.g., Kevlar® marketed by E. I. duPont de Nemours, Wilmington, Del.), and various other natural or synthetic inorganic or organic fibrous materials known for reinforcing thermoplastic compositions, e.g., spectra. Such fibers often have a nominal diameter of about 4 to about 35 micrometers, and in some embodiments, from about 9 to about 35 micrometers. The tow or fibrous bundles must contain untwisted filaments. If desired, the fibers may be in the form of rovings (e.g., bundle of fibers) that contain a single fiber type or different types of fibers. Different fibers may be contained in individual rovings or, alternatively, each roving may contain a different fiber type. For example, in one embodiment, certain rovings may contain continuous nylon-based fibers, while other rovings may contain polyester-based fibers. The number of fibers contained in each roving can be constant or vary from roving to roving.

The term “long fibers” generally refers to fibers, filaments, yarns, or rovings that are not continuous and have a length of from about 0.5 to about 25 millimeters, in some embodiments, from about 0.8 to about 15 millimeters, and in some embodiments, from about 1 to about 12 millimeters. The long fibers may be formed from any of the material, shape, and/or size as described above with respect to the continuous fibers.

Any of a variety of thermoplastic polymers may be employed to form the thermoplastic matrix in which the continuous and long fibers are embedded. Suitable thermoplastic polymers for use in the present disclosure may include, for instance, polyolefins (e.g., polypropylene, propylene-ethylene copolymers, etc.), polyesters (e.g., polybutylene terephalate (“PBT”)), polycarbonates, polyamides (e.g., Nylon™), polyether ketones (e.g., polyetherether ketone (“PEEK”)), polyetherimides, polyarylene ketones (e.g., polyphenylene diketone (“PPDK”)), liquid crystal polymers, polyarylene sulfides (e.g., polyphenylene sulfide (“PPS”)), fluoropolymers (e.g., polytetrafluoroethylene-perfluoromethylvinylether polymer, perfluoro-alkoxyalkane polymer, petrafluoroethylene polymer, ethylene-tetrafluoroethylene polymer, etc.), polyacetals, polyurethanes such as Covestro Desmomelt 530/540, polycarbonates, styrenic polymers (e.g., acrylonitrile butadiene styrene (“ABS”)), linear polyester thermoplastic or monomer such as Perstorp Capa 6400, and so forth.

Polymers that may be selected may be classified into two groups. A first group are polymers that will not adhere or bond to other substrates, but will adhere or bond to itself. An example of this type of polymer would be Perstorp Capa 6400 (a linear polyester derived from caprolactone monomer). This would primarily be used in binding, tying, plugging, and fastening systems together.

A second group are polymers that will adhere or bond to other substrates including themselves. An example of this polymer would be Covestro Desmomelt 530/540 (a flexible thermoplastic polyurethane). This would provide excellent adhesion to the reinforcing filaments as well as providing outstanding adhesion to a large number of substrates including leather, textiles, wood, metals, etc. These tapes would primarily be used in bonding applications where adhesion to the substrate to for the purpose of strengthening the substrate or repairing the substrate is required.

It is desirable of both of these polymer/reinforcement tapes is that the polymer component either melt or become “tacky” below 140 F. In this way, the tape does burn the user deploying the tape in his or her specific application. It is contemplated, that the tap may be heated during deployment by using hot water, a hair dryer or heat gun, an air or water chemical/exothermic thermal pack capable of reaching temperatures of 140 F, or microwave or ultrasonic energy to heat the tape.

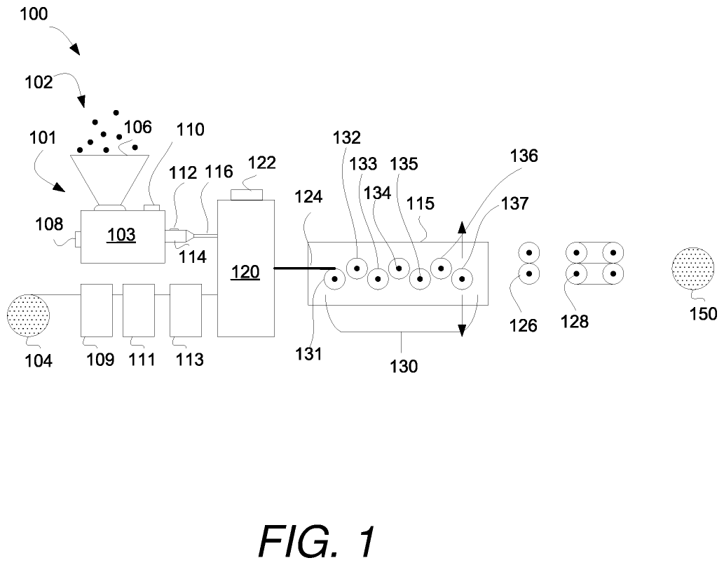

Referring now to the drawings, wherein the depictions are for the purpose of illustrating certain exemplary embodiments only and not for the purpose of limiting the same, FIG. 1 schematically shows an exemplary extrusion system 100. The system 100 includes a first extruder 101 containing a screw shaft 108 mounted inside a barrel 103. A heater 110 (e.g., electrical resistance heater) is mounted outside the barrel 103. During use, a first thermoplastic polymer feedstock 102 is supplied to the extruder 101 through a hopper 106. The feedstock 102 may contain long fibers, may be free of long fibers, and/or such fibers may be supplied at another location (not shown), such as downstream from the hopper 106 and/or other feed ports.

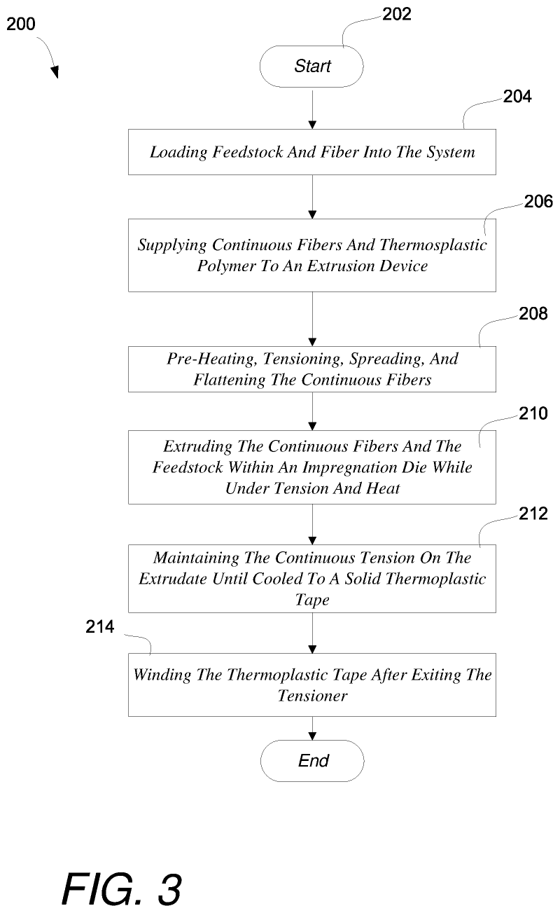

FIG. 3 shows an exemplary process 200 for forming an annealed thermoplastic tape. The process 200 may be started 202 manually by an administrator of the system 100. In some embodiments, the process 200 may be started by occurrence of an event. The polymer 102 and fiber 104 must be loaded and ready for use in the system 100.

The polymer 102 may be selected due primarily to its viscosity, heat stability, sizing adhesion promoters (maleic anhydride) and increased modulus needed to support the reinforcing fiber of a given length. Additives may be added to the polymer to enhance the interface and bonding to the reinforcing filaments and chemicals that would affect the crystallinity growth rate of that polymer.

In operation, at step 206, the thermoplastic feedstock 102 is conveyed inside the barrel 103 by the screw shaft 108 and may be heated by frictional forces inside the barrel 103 and by the heater 110. Upon being heated, the feedstock 102 exits the barrel 103 through a barrel flange 114 and enters a die flange 116 of an impregnation die 120, i.e., a melt extrusion die. A continuous fiber roving 104 or a plurality of continuous fiber rovings 104 are supplied from a reel or reels 104 to extrusion device 120. These tows or rovings are generally deployed on bobbins or spools, which usually contain several thousand yards of fiber. These selected number of rovings, on their bobbins, may be then loaded onto a creel system that allows them to be paid off without adding any twist to the roving while being tensioned.

The rovings 104 are generally kept apart a certain distance before impregnation, such as at least about 4 millimeters, and in some embodiments, at least about 5 millimeters. In one embodiment, a tension assembly 109 may be utilized to impart a tension upon the rovings 104. The tension assembly 109 may be implemented to provide a tension of an outside pull nature so as to eliminate twist in the rovings 104. Tensioning helps spread the tow to a desirable width to allow impregnation, supplies a desirable force to impregnate any particular resin due to its viscosity and heat stability and finally provides a force that goes into twisting (when desired) which also aids in removing excess resin and impregnation. This tension applied to the rovings 104 can range from a quarter of a pound to ten pounds of resistance tension placed upon the rovings 104.

In some embodiments, rovings 104 are run through a series of alternating, polished, pins or rods that may or may not be heated, that have the effect of flattening and spreading these roving bundles to a desired width and thickness.

In operation, at step 208, in various embodiments, the rovings 104 may be pre-heated in an oven 111 before moved into the die 120. Pre-heating the rovings 104, removes residual moisture from either the rovings 104 or the sizing on the rovings 104. This oven 111 could be set at temperatures anywhere from 200-degrees F. to 800-degrees F., depending on the properties of the particular type of rovings 104, sizing of the rovings 104, and the speed at which the rovings 104 travel through the oven 111. Pre-heating allows for more desirous spreading and adhesion of the matrix resin to the reinforcement surface of the rovings 104. Subsequent or concurrent with pre-heating in the oven 111, the rovings 104 may be spread and pre-heated while traveling within an assembly 113 having alternating pins with radial surfaces that further increase spreading and pre-heat of the rovings 104 at temperatures ranging from 150 F to 850 F depending on the particular type of roving 104. In one embodiment, the rovings 104 are heated to the temperature that the feedstock 102 will be at within the die 120.

The tension assembly 109 and/or the assembly 113 may have various pins or rods that may or may not be heated, that have the effect of flattening and spreading these roving bundles 104 to a desired width and thickness.

The feedstock 102 may further be heated inside the die 120 by heaters 122 mounted in or around the die 120. The die 120 is generally operated at temperatures that are sufficient to cause melting and impregnation of the thermoplastic polymer 102. Typically, the operation temperatures of the die 120 is higher than the melt temperature of the thermoplastic polymer. When processed in this manner, the continuous fiber rovings 104 become embedded in the polymer matrix, which may be a resin processed from the feedstock 102. The mixture is then extruded from the impregnation die 120 to create an extrudate 124.

A pressure sensor 112 may be used to monitor pressure near the impregnation die 120 to allow control to be exerted over the rate of extrusion by controlling the rotational speed of the screw shaft 108, or the feed rate of the feeder. That is, the pressure sensor 112 is positioned near the impregnation die 120 so that the extruder 101 can be operated to deliver a preferable amount of molten polymer for interaction with the fiber rovings 104. In various embodiments, the preferable amount of resin is an amount to sufficient to be equally spread across the rovings 104 at a percentage level that allows for the full covering of the filaments surface within the reinforcement bundle without excess. In one embodiment, the die 120 a molten stream of resin applied to the top, bottom or both sides of this band to a desired and calculated amount, usually based on weight percentages or volumes.

In operation, at step 210, in one embodiment, after leaving the die 120, the extrudate 124 moves through an impregnation die assembly 115 having a series of alternating, heated, impregnation pins. In various embodiments, these pins may also have various surface types such as convex and concave surfaces to allow the polymer to move both in an x and y direction for preferential impregnation of the extrudate 124. As FIG. 1 shows, the impregnation die assembly 115 includes a set of heated pins 130 including exemplary pin 132. In one embodiment, these pins 130 are configured to move selectively vertically as pin 132 shows, as exemplary, to apply a desired tension. The extrudate 124 is alternatingly wound on the plurality of pins, i.e., the extrudate 124 is wound on a top surface of a first pin 131, a bottom surface of a second pin 132, etc.

In operation, at step 212, a continuous tension is applied to the extrudate. These heated pins 130 within the impregnation die assembly 115 allow for the molten polymer to be worked and dispersed intimately throughout the reinforcing filaments 104 that make up the individual rovings while under continuous tension. This procedure, combined with tension that can be maintained and controlled, along with the heat and pin dimensions (surface area contact) allows for annealing of the individual filaments to increase tensile strength and thus the overall strength of the resulting tape.

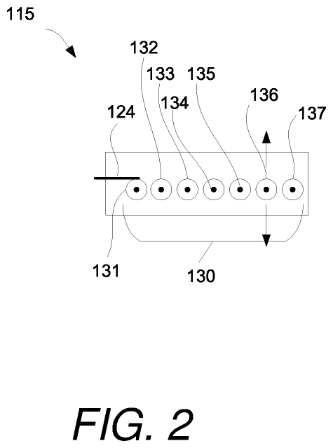

The pins 130 may be arranged to engage the extrudate 124 at a desired tension. For example, in one application, as shown in FIG. 2, the pins 130 are aligned in an alternating raised and lowered configuration, to provide additional and consistent tension on the extrudate 124. In another example, the pins 130 are aligned on a single axis, such as shown in FIG. 2. A tensioner 128 may be utilized to provide tension, as desired. By tensioning the rovings and the extrudate 124 under heat, the polymer filaments are annealed, aligning the polymer molecules. Annealing the polymer molecules or molecular chains, i.e., stretching them under heat and tension, increases tensile strength significantly. When applying heat under When annealing these polymer filaments, it is important that these filaments are locked in place so that the individual fiber bundles cannot relax, which is done by cooling while under tension.

While exiting the impregnation die assembly 115, the heated band 124 may be drawn through a slot to set the exterior dimensions. After exiting the impregnation die assembly 115, the extrudate may be chilled to a temperature at which the molten polymer becomes solid by immediately pouring temperature-controlled water and/or pulling through a chilled rolling assembly 126. The cooling is done while the extrudate is under tension to lock in the annealing. As shown, the assembly 126 includes two chilled rollers 126, however, the chilled rolling assembly 126 may include any number of chilled rollers. In one embodiment, the rollers 126 are utilized to squeeze any air within the tape while chilling. Two adjacent rollers 128 function as a tensioner and may be utilized to pull the extrudate 124 through the system 100, providing tension within the impregnation die assembly 115 and throughout the system 100, as desired.

The rolling assembly 126 may include a nip formed between two adjacent rollers to enhance fiber impregnation and squeeze out any excess voids. In various embodiments, the resulting consolidated ribbon is pulled by the tensioner 128, which may be formed of tracks 128 mounted on rollers. The tracks also pull the extrudate 124 from the impregnation die 120 and/or the impregnation die assembly 115 and through the rollers 126.

In one embodiment, the reinforcing fiber 104 would be spread into a flat band or rovings 104 through the use of tension and mechanical polished rods or through the use of pressurized air. This reinforcing band 105 may or may not need to be dried before entering a device which would heat the fiber to a desired temperature, this heating process allows for better impregnation of the polymer 102. Upon exiting the heating process, the reinforcing band of heated fiber would enter either a closed or open die device, e.g., 120 that would allow for the introduction of the impregnation polymer 102. This reinforcement, either coated or surrounded by an impregnation polymer, could then enter a series of pins or rods that would further impregnate the reinforcing fiber strand. In the case of a closed die system, this impregnating tow would either: (1) exit through a sized orifice removing all but 30 to 40% of the polymer from the extrude 124; or (2) in the case of an open die system, only 30 to 40% of the polymer would be added to the fiber and then subsequent pins would allow for further impregnation. Then this impregnated strand will be flattened while the polymer is still molten. This strand will preferably, cooled to a given temperature through the use of air, water or environmental conditions while under tension.

At step 214, after exiting the tensioner 128, a reel 150 may wind the chilled, annealed unidirectional thermoplastic composite tape for storage and transport.

In one exemplary embodiment of the system 100, six ends or packages of a Dyneema\hat{ }™, 2640, a high strength HDPE roving 104, was selected for the reinforcement part of a one inch tape. The matrix polymer 102 for this tape was a Capa\hat{ }™ 6400 linear polyester produced by Perstorp\hat{ }™. This resin has a melting point of 138 F. The individual packages where placed under three lbs. of tension. They went through eight alternating 0.75 inch pins 109 heated to a temperature of 225-degrees F. After leaving the heated pins they entered a dual hanger die 120 which delivered a molten resin to each side of the heated fiber band at a molten temperature of 245-degrees F. After leaving the die 120, coated on both sides with molten resin it entered the impregnation ladder 115 at a speed of 75 ft./min. There are ten (10) pins, 0.75-inches diameter, and heated to 255-degrees F. When the molten tape exited the last impregnation pin it entered six (6) chill rolls 126, cooled to 80 F, where the first two wheels had a ⅞ inch slot. The tape went through the tensioner 128 and was helically wound onto a cardboard core 150. The final tape had a width of ⅞ inches, 0.014 inch thickness, and had a tensile strength of 1400 lbs.

In another exemplary embodiment of the system 100, ten (10) ends or packages of Barnet\hat{ }™ 2100 dtex, high impact resistant Nylon\hat{ }™ 6 roving was selected for the reinforcement part of a 1.25-inch tape. These fibers 104 were treated with a special surface finish to promote adhesion with the urethane resin. The matrix polymer 102 for this tape was Desmopan\hat{ }™ 1080A thermoplastic polyurethane produced by Covestro\hat{ }™. This resin has a melting point of 385 F. The individual packages are placed under 2-lbs. of tension. They went through eight (8) alternating pins 109 at a temperature of 385-degrees F. to preheat and spread the fiber bundles. The fiber bundles, configured into a solid band, enter the hanger die 120 where thermoplastic urethane (Desmopan 1080A) resin is extruded onto both surfaces of the of the fiber band. The molten resin is extruded at a temperature of 415-degrees F. The coated band then enters the impregnation and annealing pins 115 at a speed of 110 ft./min and a temperature of 415-degrees F. This tape leaves the last two impregnation pins that, included a 1 3/16 inch slot cut into them, and entered 6 chill rolls 126 where the first two wheels had 1.25-inch slot cut into them and were cooled to a temperature of 110-degrees F. The tape then went through the puller 128 and was subsequently pancake wound onto a 1.25-inch cardboard core 150.

In another exemplary embodiment of the system 100, twelve (12) ends or packages of Zhejiang Guxiandao\hat{ }™ polyester yarns 104 that was selected for the reinforcement of this 1-inch tape. The matrix polymer 102 selected for this tape was Covestro's Desmomelt\hat{ }™ 540 thermoplastic urethane which is used as an adhesive in nature. The resin has a melting point of 134 F. The individual packages are placed under 2.5-lbs. of tension. They went through six (6) alternating pins 109 at a temperature of 250 F to preheat and spread the fiber bundles into a single 1-inch band. This single band then passes through a hanger die 120 at 250-degrees F. where resin is extruded onto both surfaces of this fiber band. The coated fiber band then enters the impregnation and annealing pins 115 having eight (8) alternating impregnation/annealing pins at a speed of 150 ft./min. The impregnated and annealed molten tape passes through the last two pins which have a 15/16-inch slot cut into them. This fully impregnated/annealed tape now enters a series of six chill rolls 126, where the first two rolls are cooled to a temperature of 60 F and have a 1-inch slot cut into them. The chill rolls 126 have a slightly larger slot than the impregnation pin slots because the molten tape due to tension expands outward against the chill roll slots before solidifying, keeping the 1-inch tape uniform in thickness and width. If the slots where reversed the edges of the tape would be thicker than the middle. The fully cooled/solidified band than passes through the puller 128 and onto a 3-inch card board core and pancake wound into a master package 150.

In various embodiments, the resulting annealed thermoplastic tape may be knitted or braided to form a sheet. This sheet may be laminated or pressed into a solid sheet that can be reheated and molded into a multi-axis form that conforms to the human body. These sheets could be used in ballistic, athletic, or medical protection applications.

In various embodiments, a thermoplastic composite sheet may be formed of knitted or braided, annealed or non-annealed (carbon reinforcement) thermoplastic composite tapes as described hereinabove. These sheets may be laminated or pressed into a solid sheet that can be reheated and molded into a multi-axis form that would conform to a shoe or boot. This would be for the purpose of gluing, bonding, and reinforcing areas in the construction of a shoe or boot. These reinforced shoes or boots then can be heated and reformed to match the foot they are encompassing.

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. An annealed thermoplastic tape, the tape comprising:
a plurality of unidirectional fibers; and
a thermoplastic resin.

2. The annealed thermoplastic tape of claim 1, wherein the tape is devoid of air.

3. The annealed thermoplastic tape of claim 1, wherein the tape is annealed by a process comprising:
simultaneously tensioning the fiber and applying heat and heated resin to the fiber to form the thermoplastic tape, wherein the tensioning is applied at a strength great enough to stretch the fiber; and
maintaining tension on the thermoplastic tape until cooled to a solid.

4. The annealed thermoplastic tape of claim 3, wherein the tape has a higher tensile strength then the fiber.

5. The annealed thermoplastic tape of claim 1, wherein the fiber is a HDPE fiber and the resin is a linear polyester diol thermoplastic resin.

6. The annealed thermoplastic tape of claim 1, wherein the tape has a greater tensile strength at negative 80-degrees F. than it has at 68-degrees F.

7. The annealed thermoplastic tape of claim 1, wherein the fiber is a polyester fiber.

8. The annealed thermoplastic tape of claim 1, wherein the fiber is capable of stretching when under tension before annealed with the thermoplastic resin.

9. A method for forming an annealed thermoplastic tape, the method comprising:
supplying continuous fibers to an extrusion device;
supplying a thermoplastic feedstock to the extrusion device, wherein the feedstock comprises a thermoplastic polymer;
pre-heating, tensioning, spreading, and flattening the continuous fibers;
extruding the continuous fibers and the feedstock within an impregnation die to form an extrudate in which the continuous fibers are embedded with a matrix of the thermoplastic polymer while under continuous tension and heat; and
maintaining the continuous tension on the extrudate until cooled to a solid thermoplastic tape.

10. The method of claim 9, wherein the maintaining the continuous tension on the thermoplastic tape is executed, in part, by a plurality of pins within the impregnation die.

11. The method of claim 10, wherein the extrudate is alternatingly wound on the plurality of pins to consistently apply tension throughout the extrudate.

12. The method of claim 9, wherein the maintaining the continuous tension on the thermoplastic tape is executed, in part, by a tensioner formed of at least one top roller and at least one bottom roller.

13. The method of claim 12, further comprising:
winding the thermoplastic tape after exiting the tensioner, wherein the tape exits at a faster rate than the continuous fibers are supplied to the extrusion device, under the same constant tension.

14. The method of claim 9, further comprising: squeezing the extrudate while under tension after exiting the impregnation die to remove any air pockets.

15. The method of claim 9, further comprising: adjusting a vertical position of at least one of the plurality of pins.

16. The method of claim 9, wherein the continuous fiber is a HDPE fiber and the thermoplastic feedstock is a linear polyester diol thermoplastic resin.

17. The method of claim 9, wherein the fiber is a polyester fiber.

18. The method of claim 9, wherein the continuous tension is a maintained at a tension strong enough to stretch the continuous fiber, but less than a strength necessary to break the continuous fiber.

19. The method of claim 9, further comprising:
forming the thermoplastic tape into knitted, braided, woven, or layered/plied sheets

20. The method of claim 19, further comprising:
reheating the knitted, braided, woven, layered/plied sheets; and
molding the knitted, braided, woven, layered/plied sheets into a predefined multi-axis portion.
